(19) United States
(12) Patent Application Publication
(10) Pub. No.: US 2006/0205837 A1
(43) Pub. Date: Sep. 14, 2006

(54) Compounds which can be activated by actinic radiation and contain urethane groups, method for the production thereof and use of the same

(75) Inventors: Uwe Meisenburg, Duisbury (DE); Heinz-Peter Rink, Munster (DE); Daniel Couturier, Gruson (FR); Isabelle Couturier-Verlhac, Lille (FR)

Correspondence Address: BASF CORPORATION, 1609 BIDDLE AVENUE, WYANDOTTE, MI, 48192, US

(73) Assignee: BASF Coatings Aktiengesellschaft, Munster (DE)

(21) Appl. No.: 10/533,112

(22) PCT Filed: Oct. 27, 2003
(86) PCT No.: PCT/EP03/11895

§ 371 Date: Apr. 28, 2005

(30) Foreign Application Priority Data
Nov. 15, 2002 (DE) 102 53 289.3

(51) Int. Cl. C03C 25/10

(52) U.S. Cl. 522/96

(57) ABSTRACT

Compounds which can be activated by actinic radiation, contain at least one urethane group, and have the general formula I:
X[N(R)—C(O)—O—C(R¹R²)—C(R³R⁴)—Y-Z]ₙ (I), in which the index and the variables have the following meanings: n is an integer from 1 to 5; X is an at least n-valent, substituted or unsubstituted organic radical; R is a hydrogen atom or a monovalent substituted or unsubstituted organic radical;
R¹-R⁴ independently of one another are a hydrogen atom, halogen atom or monovalent, substituted or unsubstituted organic radical, it being possible for at least two radicals to be cyclically linked to one another; Y is a divalent, linking functional group containing at least one oxygen atom; and Z is an organic radical containing at least one group which can be activated by actinic radiation; with the proviso that at least for n=1 the radical R and/or the radical X are/is substituted by at least one substituent of the general formula II:
   Z—Y— (II), in which the variables Z and Y are as defined above; processes for preparing them, and their use.

The present invention relates to novel compounds which contain urethane groups and can be activated by actinic radiation. The present invention further relates to a novel process for preparing compounds which contain urethane groups and can be activated by actinic radiation. The present invention additionally relates to the use of the novel compounds which contain urethane groups and can be activated by actinic radiation, and also the compounds which contain urethane groups and can be activated by actinic radiation, prepared by the novel process, as compositions curable by actinic radiation and for preparing compositions which are curable by actinic radiation and/or thermally. The present invention relates not least to the use of the novel curable compositions to produce moldings and films or as coating materials, adhesives, and sealants to produce coatings, coating systems, adhesive films, and seals.

Compounds which contain urethane groups and can be activated by actinic radiation, such as hexafunctional urethane acrylates, have been known for a long time (cf., for example, German patent application DE 198 18 735 A1, column 7, lines 1 to 35) and are available commercially, for example, under the brand name Ebecryl® 1290 from UCB Chemie. They are technologically valuable constituents of compositions which can be cured with UV radiation or electron beams. Owing to their comparatively low molecular weight they are also referred to as reactive diluents (cf. Römpp Lexikon Lacke und Druckfarben, Georg Thieme Verlag, Stuttgart, N.Y., 1998, page 491, “Reactive diluents”). They are normally prepared by reacting polyisocyanates with hydroxyalkyl acrylates. Apart from the safety problems which may result from the toxicity of the products of the polyisocyanates, the preparation process may be accompanied by side reactions of the polyisocyanates, with the formation of allophanate, uretdion or urea groups.

There is therefore a need for compounds which contain urethane groups and can be cured by UV radiation or electron beams and which have the same advantageous level of technological properties as the existing urethane acrylates, or exceed said level, and which can be prepared without the use of polyisocyanates.

It is an object of the present invention to meet this need and to provide novel compounds which can be cured with actinic radiation and contain urethane groups and which have the same advantageous level of properties as the existing urethane acrylates or even exceed said level and which can be produced simply and with reliable reproducibility without the use of polyisocyanates.

The novel compounds containing urethane groups and curable by actinic radiation ought in particular to be suitable as compositions curable by actinic radiation or for preparing compositions curable by actinic radiation and/or thermally.

The novel compositions curable by actinic radiation and/or thermally ought to have solid contents of up to 100% by weight while in the absence of actinic radiation being stable on storage and easy to process, particularly to apply. Moreover, they ought to be rapidly curable by means of the conventional methods for curing by actinic radiation and/or thermal curing, so that they are especially suitable for producing moldings and films and as coating materials, adhesives, and sealants for producing coatings, coating systems, adhesives, and seals.

The novel moldings, films, coatings, coating systems, adhesive films, and seals ought to have a particularly good profile of performance properties and to be capable of application to such technologically demanding fields as packaging, wrapping, protective and/or decorative coating or painting, the adhesive bonding and the sealing of motor vehicles, aircraft, rail vehicles, ships, constructions, furniture, windows and doors or parts thereof, small industrial parts, coils, freight containers, packaging, white goods, films, optical components, electrical components, mechanical components, and hollow glassware.

The invention accordingly provides the novel compounds which can be activated by actinic radiation, contain at least one urethane group, and have the general formula I:
X[N(R)—C(O)—O—C(R¹R²)—C(R³R⁴)—Y-Z]ₙ (I),
in which the index and the variables have the following meanings:
n is an integer from 1 to 5;
X is at least a n-valent, substituted or unsubstituted organic radical;
R is a hydrogen atom or a monovalent substituted or unsubstituted organic radical;
R¹-R⁴ independently of one another are a hydrogen atom, halogen atom or monovalent, substituted or unsubstituted organic radical, it being possible for at least two radicals to be cyclically linked to one another;
Y is a divalent, linking functional group containing at least one oxygen atom; and
Z is an organic radical containing at least one group which can be activated by actinic radiation;
   with the proviso that at least for n=1 the radical R and/or the radical X are/is substituted by at least one substituent of the general formula II:
   Z—Y— (II),
   in which the variables Z and Y are as defined above.

The novel compounds containing at least one urethane group and curable with actinic radiation are referred to below as “compounds of the invention”.

The invention further provides the novel process for preparing compounds which contain at least one urethane group and can be activated with actinic radiation, which involves reacting
(1) at least one compound which contains at least one urethane group and has the general formula IV:
   X¹[N(R⁵)—C(O)—O—C(R¹R²)—C(R³R⁴)—OH]ₙ (IV),
   in which the index n and the variables R¹, R², R³ and R⁴ are as defined above and the variable X¹ is an n-valent and the variable R⁵ a monovalent, hydroxyl-containing or hydroxyl-free substituted (substituents of the general II being excluded) or unsubstituted, organic radical; with the proviso that at least for n=1 the radical X¹ and/or the radical R⁵ contain/contains one hydroxyl group; with
(2) at least one compound of the general formula V:
   Y¹-Z (V),
   in which the variable Z is as defined above and the variable Y¹ is a reactive functional group which forms at least one group Y with the hydroxyl group or groups of the compounds of the general formula IV;
      in a Y¹:OH equivalents ratio≧1.0.

The novel process for preparing compounds which contain at least one urethane group and can be activated with actinic radiation is referred to below as “process of the invention”.

Additional subject matter of the invention will emerge from the description.

In the context of the present invention, actinic radiation means electromagnetic radiation, such as near infrared (NIR), visible light, UV radiation, x-rays and gamma radiation, especially UV radiation, and corpuscular radiation, such as electron beams, proton beams, alpha radiation, and neutron beams, especially electron beams.

The compounds of the invention are distinguished by the following structural features.

In the general formula I the index n is an integer from 1 to 5, preferably from 1 to 3 and in particular 1 and 2.

The variable X of the general formula I is an at least n-valent, preferably at least monovalent or divalent, and in particular monovalent or divalent, organic radical.

Suitable monovalent organic radicals X include or consist of alkyl, cycloalkyl and/or aryl groups, especially alkyl and/or cycloalkyl groups.

The alkyl, cycloalkyl and/or aryl groups X may contain
heteroatoms, such as oxygen atoms, nitrogen atoms, sulfur atoms and/or phosphorus atoms, especially oxygen atoms, and also
functional groups which contain these heteroatoms, such as ether, thioether, carboxylate, thiocarboyxlate, carbonate, thiocarbonate, phosphate, thiophosphonate, phosphonate, thiophosphate, phosphite, thiophosphite, sulfonate, amide, amine, thioamide, phosphoramide, thiophosphoramide, phosphonamide, thiophosphonamide, sulfonamide, imide, hydrazide, urea, thiourea, carbonyl, thiocarbonyl, sulfone or sulfoxide groups, especially ether and/or carboxylate groups.

Particular preference is given to using alkyl groups, cycloalkyl groups, and alkylcycloalkyl groups X which are free from the stated heteroatoms and from the stated functional groups.

Examples of especially suitable monovalent organic radicals X are branched and unbranched, preferably unbranched alkyl groups X having from 1 to 20 carbon atoms, especially methyl, ethyl, propyl, isopropyl, n-butyl, isobutyl, tertiary-butyl, pentyl, hexyl, heptyl, octyl, isooctyl, nonyl, decyl, undecyl, dodecyl, tridecyl, tetradecyl, pentadecyl, hexadecyl, heptadecyl, octadecyl, nonadecyl and eicosanyl; cycloalkyl groups X having from 4 to 10 carbon atoms, especially cyclobutyl, cyclopentyl, cyclohexyl, cycloheptyl, cycloctyl, cyclononyl, cyclodecyl, norbornyl, adamantyl, camphanyl, p-menthanyl and tricyclodecyl; and alkylcycloalkyl groups X, especially cyclohexyl methyl, 2-cyclohexyleth-1-yl and 3-cyclohexylprop-1-yl. Ethyl is used in particular.

Suitable divalent organic radicals X include or consist of alkanediyl, cycloalkanediyl and/or arylene groups, especially alkanediyl and/or cycloalkanediyl groups.

The alkanediyl, cycloalkanediyl and/or arylene groups X may contain
heteroatoms, such as oxygen atoms, nitrogen atoms, sulfur atoms and/or phosphorus atoms, especially oxygen atoms, and also
functional groups which contain these heteroatoms, such as ether, thioether, carboxylate, thiocarboyxlate, carbonate, thiocarbonate, phosphate, thiophosphate, phosphonate, thio-phosphonate, phosphite, thiophosphite, sulfonate, amide, amine, thioamide, phosphoramide, thiophosphoramide, phosphonamide, thiophosphonamide, sulfonamide, imide, hydrazide, urea, thiourea, carbonyl, thiocarbonyl, sulfone or sulfoxide groups, especially ether and/or carboxylate groups.

Particular preference is given to using alkanediyl groups, cycloalkanediyl groups, and alkanecyclo-alkanediyl groups X which are free from the stated heteroatoms and from the stated functional groups.

Example of especially suitable divalent organic radicals X are branched and unbranched, preferably unbranched, alkanediyl groups X having from 1 to 20 carbon atoms, especially methylene, ethylene, trimethylene, tetramethylene, pentamethylene, hexamethylene, heptamethylene, octamethylene, nonamethylene, decane-1,10-diyl, undecane-1,11-diyl, dodecane-1,12-diyl, tridecane-1,13-diyl, tetradecane-1,14-diyl, pentadecane-1,15-diyl, hexadecane-1,16-diyl, heptadecane-1,17-diyl, octadecane-1,18-diyl, nonadecane-1,19-diyl and eicosane-1,20-diyl; and also cycloalkanedialkyl groups X, especially 1,2-, 1,3-, and 1,4-cyclohexane dimethyl.

In the general formula I the variable R is a hydrogen atom or a monovalent substituted or unsubstituted organic radical. Examples of suitable organic radicals R are the monovalent substituted and unsubstituted organic radicals X described above.

In the general formula I the variables R¹, R², R³, and R⁴ independently of one another are hydrogen atoms, halogen atoms, especially fluorine atoms, chlorine atoms, and bromine atoms, and monovalent substituted and unsubstituted organic radicals, it being possible for at least two radicals R¹, R², R³, and R⁴ to be cyclically linked to one another. Examples of suitable monovalent substituted or unsubstituted organic radicals R¹, R R³, and R⁴ are the monovalent substituted and unsubstituted organic radicals X described above. Particular preference is given to using hydrogen atoms.

In the general formula I the variable Y is a divalent linking functional group which contains at least one oxygen atom. Examples of suitable divalent linking functional groups which contain at least one oxygen atom are ether, carboxylate, carbonate, phosphate, phosphonate, phosphite ester and sulfonate groups, especially carboxylate groups.

In the general formula I the variable Z is an organic radical containing at least one, especially one, group which can be activated by actinic radiation.

The groups which can be activated by actinic radiation contain at least one, especially one, bond which can be activated by actinic radiation. By this is meant a bond which on exposure to actinic radiation becomes reactive and, together with other activated bonds of this kind, enters into polymerization reactions and/or crosslinking reactions which proceed in accordance with free-radical and/or ionic mechanisms. Examples of suitable bonds are carbon-hydrogen single bonds or carbon-carbon, carbon-hydrogen, carbon-nitrogen, carbon-phosphorus or carbon-silicon single or double bonds or carbon-carbon triple bonds. Of these, the carbon-carbon double bonds and triple bonds are advantageous and are therefore used with preference. Particular advantage attaches to the carbon-carbon double bonds, which is why they are used with particular preference. For the sake of brevity they are referred to below as “double bonds”.

The radicals Z are preferably of the general formula III:

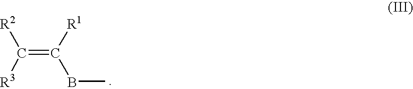

In the general formula III the variables R¹, R², and R³ are as defined above and the variable —B— is a single bond between the carbon atom of the double bond and one of the above-described divalent linking functional groups Y or is one of the above-described divalent substituted or unsubstituted linking organic radicals X.

Examples of highly suitable radicals Z of the general formula III are vinyl, 1-methylvinyl, 1-ethylvinyl, propen-1-yl, styryl, cyclohexenyl, endomethylene-cyclohexyl, norbornenyl and dicyclopentadienyl groups, especially vinyl groups.

Accordingly, the particularly preferred groups Z which can be activated with actinic radiation are (meth)acrylate, ethacrylate, crotonate, cinnamate, cyclohexenecarboxylate, endomethylenecyclohexane-carboxylate, norbornenecarboxylate, and dicyclo-pentadienecarboxylate groups, but in particular (meth)acrylate groups, especially acrylate groups.

The organic radicals X, R, R¹, R², R³, and R⁴ are substituted or unsubstituted. Suitable substituents include all customary and known groups and atoms commonly used in organic chemistry. A prerequisite is that these groups and atoms do not inhibit or prematurely initiate the curing of the compounds of the invention that is an aim of the invention, and/or do not lead to unwanted byproducts. Examples of suitable atoms are fluorine atoms or chlorine atoms. Examples of suitable groups are nitrile groups, nitro groups, alkoxy groups, cycloalkyloxy groups, or aryloxy groups or the substituents of the general formula II:
Z—Y— (II).

In the general formula II the variables Y and Z are as defined above.

If in the general formula I the index n=1, the radical R and/or the radical X are/is substituted by at least one, especially one, substituent of the general formula II.

Examples of the above-described compounds of the invention are
I-1 N-(2-acryloyloxyethyl)-2′-acryloyloxyethyl carbamate,
I-2 N-(2-acryloyloxyethyl)-3′-acryloyloxypropyl carbamate,
I-3 N-(2-acryloyloxyethyl)-4′-acryloyloxybutyl carbamate,
I-4 1,2-bis(N-(2-acryloyloxyethyloxycarbonyl-amino)ethane,
I-5 1,3-bis(N-2-acryloyloxyethyloxycarbonyl-amino)propane,
I-6 1,6-bis(N-2-acryloyloxyethyloxycarbonyl-amino)hexane,
I-7 1,3-bis(N-2-acryloyloxyethyloxycarbonylamino-methyl)cyclohexane, and
I-8 N,N-bis(2-acryloyloxyethyl)-2′-acryloyloxyethyl carbamate.

The compounds of the invention can be prepared with the aid of conventional methods of preparative organic chemistry. They are preferably obtained by means of the process of the invention.

In the process of the invention at least one, especially one, compound which contains at least one urethane group, in particular one urethane group or two urethane groups, and is of the general formula IV:
X¹ [N(R⁵)—C(O)—O—C(R¹, R²)—C(R³R⁴)—OH]ₙ (IV),
is reacted with at least one, especially one, compound of the general formula V
Y¹-Z (V),
in a Y¹:OH equivalents ratio ≧1.0, preferably ≧1.1, more preferably ≧1.2, with particular preference ≧1.3, and, in particular, ≧1.4.

In the general formula IV the index n and the variables R¹, R², R³, and R⁴ are as defined above. The variable X¹ is an n-valent and the variable R⁵ a monovalent, hydroxyl-containing or hydroxyl-free, substituted (substituents of the general formula II being excluded) or unsubstituted organic radical, with the proviso that at least for n=1 the radical X¹ and/or the radical R⁵ contain/contains at least one, especially one, hydroxyl group.

Examples of suitable n-valent radicals X¹ are the above-descried n-valent substituted or unsubstituted organic radicals X, substituents of the general formula II being excluded.

Examples of suitable monovalent radicals R⁵ are the above-described substituted or unsubstituted organic radicals X, substituents of the general formula II being excluded.

Examples of suitable compounds of the general formula IV are
IV-1 N-(2-hydroxyethyl)-2′-hydroxyethyl carbamate,
IV-2 N-(3-hydroxypropyl)-2′-hydroxyethyl carbamate,
IV-3 N-(2-hydroxybutyl)-2′-hydroxyethyl carbamate,
IV-4 1,2-bis(N-2-hydroxyethyloxycarbonylamino)-ethane,
IV-5 1,3-bis(N-2-hydroxyethyloxycarbonylamino)-ethane,
IV-6 1,6-bis(N-2-hydroxyethyloxycarbonylamino)-propane,
IV-7 1,3-bis(N-2-hydroxyethyloxycarbonylamino-methyl)cyclohexane, and
IV-8 N,N-bis(2-hydroxyethyl)-2′-hydroxyethyl carbamate.

In particular, compound IV-1 is used to prepare the inventive compound I-1, compound IV-2 is used to prepare the inventive compound I-2, compound IV-3 is used to prepare the inventive compound I-3, compound IV-4 is used to prepare the inventive compound I-4, compound IV-5 is used to prepare the inventive compound I-5, compound IV-6 is used to prepare the inventive compound I-6, compound IV-7 is used to prepare the inventive compound I-7, and compound IV-8 is used to prepare the inventive compound I-8.

The compounds of the general formula IV can be prepared with the aid of conventional methods of low molecular mass organic chemistry. They are preferably prepared by reacting
(1) at least one 1,3-dioxolan-2-one of the general formula VI: 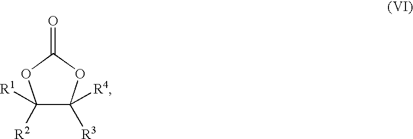
in which the variables R¹, R R³, and R⁴ are as defined above; with
(2) at least one compound which contains at least one, especially one or two, primary and/or secondary amino group(s) and has the general formula VII:
   X¹[N(R⁵)H]ₙ (VII),
   in which the index and the variables X¹ and R⁵ are as defined above,
      in an amino group: carbonate group equivalents ratio=0.8 to 1.2, preferably from 0.9 to 1.1, and in particular from 0.95 to 1.05.

One example of a suitable compound of the general formula VI is 1,3-dioxolan-2-one.

Examples of suitable compounds of the general formula VII are ethanolamine, propanolamine, ethylene-1,2-diamine, propylene-1,3-diamine, tetramethylene-1,4 diamine, hexamethylene-1,6-diamine, 1,3-bis(amino-methyl)cyclohexane, and diethanolamine.

In terms of method the reaction presents no peculiarities but is instead carried out with the aid of the conventional methods and apparatus of preparative organic chemistry, batchwise or continuously.

In the general formula V the variable Z is as defined above. The variable Y¹ is a reactive functional group which together with the hydroxyl group or groups of the compounds of the general formula IV forms at least one of the above-described divalent linking functional groups Y containing at least one oxygen atom.

The reactive functional groups Y¹ are preferably selected from the group consisting of halogen atoms, carboxylic acid, sulfonic acid, phosphoric acid, phosphonic acid, and phosphorous acid groups; carbonyl halide, sulfonic halide, phosphoric halide, phosphoryl halide groups; carboxylic anhydride, sulfonic anhydride, phosphoric anhydride, phosphonic anhydride and phosphoryl anhydride groups; carboxylic, sulfonate, phosphate, phosphonate, and phosphite groups; and also epoxide, N-methylol, and N-methylol ether groups, preferably carboxylic acid, carboxylic anhydride, carbonyl halide groups, especially carbonyl halide and carboxylate groups, in particular methyl and ethyl ester groups.

Examples of highly suitable compounds of the general formula V are acrylic acid, methacrylic acid, ethacrylic acid, crotonic acid, cinnamic acid, cyclohexenecarboxylic acid, endomethylenecyclohexane-carboxylic acid, norbornenecarboxylic acid, and dicyclopentadienecarboxylic acid, especially acrylic acid, their anhydrides, halides, especially chlorides, and esters, especially methyl and ethyl esters. Particular preference is given to using methyl acrylate and acryl chloride.

The reaction of the compounds of the general formula IV with the compounds of the general formula V likewise presents no methodological peculiarities but instead is carried out with the aid of the conventional methods and apparatus of preparative organic chemistry, especially with the aid of the methods and apparatus for esterifying hydroxyl-containing compounds, batchwise or continuously.

The process of the invention provides the compounds of the invention safely, reliably, and in particularly high yields, without the need to use polyisocyanates.

The compounds of the invention can be used very advantageously for all end uses of customary and known compounds which contain groups which can be activated by actinic radiation, especially acrylate groups. In this context they can be used as full substitutes for the known compounds.

In particular they are used as compositions curable by actinic radiation, thermally or both thermally and by actinic radiation, or for preparing compositions curable by actinic radiation, thermally, or both thermally and by actinic radiation. They are referred to collectively below as “compositions of the invention.”

The compositions of the invention preferably serve as coating materials, adhesives or sealants for producing coatings, coating systems, adhesive films, and seals, and also for producing moldings and self-supporting films.

The compositions of the invention may comprise all customary and known constituents of compositions which can be cured by actinic radiation, such as additional radiation-curable binders, radiation-curable reactive diluents, and photoinitiators. They may further comprise customary and known auxiliaries and additives, such as light stabilizers, adhesion promoters (tackifiers), slip additives, leveling agents, polymerization inhibitors, flatting agents, nanoparticles, and film-forming auxiliaries.

Examples of suitable customary and known constituents of compositions curable by actinic radiation are known, for example, from German patent DE 197 09 467 C 1, page 4, line 30 to page 6, line 30, or from German patent application DE 199 47 523 A1.

If the composition of the invention is curable thermally as well, i.e., is a dual-cure composition, it preferably further comprises customary and known thermosetting binders and crosslinking agents, which may additionally contain groups which can be activated by actinic radiation, and/or thermosetting reactive diluents, as is described, for example, in German patent applications DE 198 187 735 A1 and DE 199 20 799 A1 or in European patent application EP 0 928 800 A1.

Following the addition of customary and known thermally activatable initiators, such as peroxides, azo compounds, and C—C-labile compounds, the compositions of the invention may also be cured by means of heat alone.

The compositions of the invention are preferably prepared by mixing the constituents described above in suitable mixing equipment such as stirred tanks, stirrer mills, extruders, kneaders, Ultraturrax, inline dissolvers, static mixers, micromixers, toothed wheel dispersers, pressure relief nozzles and/or microfluidizers. It is preferred in this case to operate in the absence of light with a wavelength λ<550 nm or with complete exclusion of light, in order to prevent premature crosslinking of the compositions of the invention.

The compositions of the invention may be present in a very wide variety of forms. Accordingly, they are conventional compositions containing organic solvents, aqueous compositions, substantially or completely solvent-free and water-free liquid compositions (100% systems), substantially or completely solvent-free and water-free solid powders, or substantially or completely solvent-free powder suspensions (powder slurries). They may also be one-component systems, in which the binders and the crosslinking agents are present alongside one another, or two-component or multicomponent systems, in which the binders and the crosslinking agents are separate from one another until shortly before application.

The compositions of the invention are used to produce cured compositions, especially coatings, paint systems, moldings, and self-supporting films.

To produce the moldings and films of the invention the compositions of the invention are applied to conventional temporary or permanent substrates. For the production of the films and moldings of the invention it is preferred to use conventional temporary substrates, such as metal or plastic belts or hollow metal, glass, plastic, wood or ceramic bodies, which can be removed easily without damaging the films and moldings of the invention.

Where the compositions of the invention are used for producing coatings, adhesive films, and seals, permanent substrates are used, such as aircraft, ships, rail vehicles, motor vehicles and parts thereof, interior and exterior constructions and parts thereof, doors, windows, furniture, hollow glassware, coils, freight containers, packaging, small industrial parts, optical components, electrical components, mechanical components, and components for white goods. The films and moldings of the invention may likewise serve as substrates.

In terms of method the application of the liquid compositions of the invention has no special features but may instead take place by any customary and known application method, such as spraying, squirting, knife coating, brushing, pouring, dipping, trickling, or rolling, for example.

The application of the composition of the invention in powder form also has no special features as far as the method is concerned but instead takes place, for example, in accordance with the customary and known fluid-bed methods, such as are known, for example, from the BASF Coatings AG brochures “Pulverlacke für industrielle Anwendungen”, January 2000, or “Coatings Partner, Pulverlack Spezial”, 1/2000, or Römpp Lexikon Lacke und Druckfarben, Georg Thieme Verlag, Stuttgart, N.Y., 1998, pages 187 and 188, “Electrostatic powder spraying”, “Electrostatic spraying”, and “Electrostatic fluidized bath process”.

In the course of application it is advisable to work in the absence of actinic radiation in order to prevent premature crosslinking of the composition of the invention.

The applied compositions of the invention are preferably cured by UV radiation. During irradiation it is preferred to use a radiation dose of from 100 to 6 000, preferably from 200 to 3 000, more preferably from 300 to 2 000, and with particular preference from 500 to 1 800 mJ cm⁻², the region <1 700 mJ cm⁻² being especially preferred.

The radiation intensity may vary widely. It is guided in particular by the radiation dose on the one hand and by the irradiation time on the other. The irradiation time is guided, for a given radiation dose, by the belt speed or rate of advance of the substrates in the irradiation unit, and vice versa.

As radiation sources for the UV radiation it is possible to use all customary and known UV lamps. Flash lamps as well are suitable. As UV lamps it is preferred to use mercury vapor lamps, preferably low, medium, and high pressure mercury vapor lamps, particularly medium pressure mercury vapor lamps. Particular preference is given to using unmodified mercury vapor lamps plus suitable filters, or modified, especially doped, mercury vapor lamps.

Preference is given to using gallium-doped and/or iron-doped, especially iron-doped, mercury vapor lamps, as described, for example, in R. Stephen Davidson, “Exploring the Science, Technology and Applications of UV and EB Curing”, Sita Technology Ltd., London, 1999, Chapter I, “An Overview”, page 16, FIG. 10, or Dipl.-Ing. Peter Klamann, “eltosch System-Kompetenz, UV-Technik, Leitfaden für Anwender”, page 2, October 1998.

Examples of suitable flash lamps are flash lamps from the company VISIT.

The distance of the UV lamps from the applied compositions of the invention may vary surprisingly widely and can therefore be adjusted very well to the requirements of the case in hand. The distance is preferably from 2 to 200, more preferably from 5 to 100, with particular preference from 10 to 50, and in particular from 15 to 30 cm. The arrangement of the lamps may also be adapted to circumstances of the substrate and the process parameters. In the case of substrates of complex shape, such as are envisaged for automobile bodies, those regions not accessible to direct radiation (shadow regions), such as cavities, folds, and other structural undercuts, can be cured using pointwise, small-area or all-round emitters, in conjunction with an automatic movement means for the irradiation of cavities or edges.

Irradiation can be carried out under an oxygen-depleted atmosphere. “Oxygen-depleted” means that the oxygen content of the atmosphere is lower than that of air (20.95% by volume). The atmosphere may in principle also be oxygen-free; that is, may comprise an inert gas. Owing to the absence of the inhibiting effect of oxygen, however, this may also result in a drastic acceleration of radiation curing, possibly resulting in inhomogeneities and stresses in the cured compositions of the invention. It is therefore advantageous not to lower the oxygen content of the atmosphere to zero % by volume.

The applied, thermally curable or dual-cure compositions of the invention can be subjected to thermal curing with the aid, for example, of a gaseous, liquid and/or solid hot medium, such as hot air, heated oil or heated rollers, or with the aid of microwave radiation, infrared light and/or near infrared (NIR) light. Heating preferably takes place in a forced-air oven or by irradiation using IR and/or NIR lamps. As is the case for curing with actinic radiation, thermal curing as well may take place in stages. Thermal curing takes place advantageously at temperatures from room temperature to 200° C.

Both thermal curing and actinic radiation curing may be carried out in stages. Such stages may take place one after the other (sequentially) or simultaneously. In accordance with the invention, sequential curing is of advantage and is therefore used with preference. It is a particular advantage in this context to carry out the thermal cure after the actinic radiation cure.

The resultant films, moldings, coatings, adhesive films, and seals of the invention are outstandingly suitable for the coating, adhesive bonding, sealing, wrapping, and packing of aircraft, ships, rail vehicles, motor vehicles and parts thereof, interior and exterior constructions and parts thereof, doors, windows, furniture, hollow glassware, coils, freight containers, packaging, small industrial parts, such as nuts, bolts, wheel rims or hubcaps, electrical components, such as wound goods (coils, stators, rotors), optical components, mechanical components, and components for white goods, such as radiators, domestic appliances, refrigerator casings or washing machine casings.

In particular, however, the compositions of the invention are used as coating materials, preferably as topcoat materials or clearcoat materials, especially as clearcoat materials, for producing multicoat color and/or effect, electrically conductive, magnetically shielding or fluorescent paint systems, especially multicoat color and/or effect paint systems. For producing the multicoat paint systems it is possible to employ customary and known wet-on-wet techniques and coat systems.

The resultant clearcoats of the invention are the outermost coats of the multicoat paint systems, which substantially determine the overall appearance and protect the color and/or effect coats against mechanical and chemical damage and damage by radiation. Consequently, deficiencies in the hardness, scratch resistance, chemical resistance, and yellowing stability are particularly manifest in the clearcoat. The clearcoats of the invention, however, exhibit only little yellowing. They are highly scratch resistant and after scratching exhibit only very minor losses of gloss. At the same time they possess a high hardness. Not least, they have a particularly high chemical resistance and adhere very firmly to the color and/or effect coats.

The substrates of the invention which are coated with coatings of the invention, adhesively bonded with adhesive films of the invention, sealed with seals of the invention and/or wrapped or packed with films and/or moldings of the invention therefore have outstanding long-term service properties and a particularly long service life.

### EXAMPLES

### Preparation Examples 1 to 8

The Preparation Compounds IV-1 to IV-8

Compounds IV-1 to IV-8 were prepared in accordance with the following general instructions.

In a suitable stirred vessel, 1,3-dioxolan-2-one and a compound of the general formula VII were mixed at room temperature in an amino group: carbonate group equivalents ratio=1:1. An exothermic reaction occurred. After the production of heat had subsided, the reaction was at an end. Compound IV was obtained in quantitative yield.

For preparation examples 1 to 8 the following compounds of the general formula VII were used, to give the corresponding compounds IV-1 to IV-8.

### Preparation Example 1

VII-1 ethanolamine, IV-1 N-(2-hydroxyethyl)-2′-hydroxyethyl carbamate,

### Preparation Example 2

VII-2 propanolamine, IV-2 N-(3-hydroxypropyl)-2′-hydroxyethyl carbamate,

### Preparation Example 3

VII-3 ethylene-1,2-diamine, IV-3 N-(4-hydroxybutyl)-2′-hydroxyethyl carbamate,

### Preparation Example 4

VII-4 propylene-1,3-diamine, IV-4 1,2-bis(N-2-hydroxyethyloxycarbonylamino)ethane,

### Preparation Example 5

VII-5 tetramethylene-1,4-diamine, IV-5 1,3-bis-(N-2-hydroxyethyloxycarbonylamino)propane,

### Preparation Example 6

VII-6 hexamethylene-1,6-diamine, IV-6 1,6-bis-(N-2-hydroxyethyloxycarbonylamino)hexane,

### Preparation Example 7

VII-7 1,3-bis(aminomethyl)cyclohexane, IV-7 1,3-(N-2-hydroxyethyloxycarbonylaminomethyl)cyclohexane and

### Preparation Example 8

VII-8 diethanolamine, IV-8 N,N-bis(2-hydroxyethyl)2′-hydroxyethyl carbamate

### Examples 1 to 11

Preparation of Compounds I-1 to I-8

### Examples 1 to 3

The Preparation of Compounds I-1,1-5 and 1-7

The compounds I-1 (example 1), I-5 (example 2), and I-7 (example 3) were prepared in accordance with the following general instructions.

In a suitable reaction vessel, 150 parts by weight of compound IV-1, IV-5 or IV-7 were heated at reflux with stirring with a molar excess, based on the hydroxyl groups present in the compound IV, of methyl acrylate in the presence of 4 parts by weight of p-toluol sulfonic acid (catalyst) and 8 parts by weight of hydroquinone (stabilizer). The azeotrope comprising methanol and methyl acrylate was subsequently distilled off. After 10 hours the reaction mixture was cooled and compounds I-1, I-5 or I-7 were isolated by vacuum distillation, with the following yields:

I-1 N-(2-acryloyloxyethyl)-2′-acryloyloxyethyl carbamate (81%),

I-5 1,3-bis(N-2-acryloyloxyethyloxycarbonylamino)-propane (71%), and

I-7 1,3-bis(N-2-acryloyloxyethyloxycarbonylamino-methyl)cyclohexane (70%).

The compounds I-1, I-5, and I-7 were characterized by means of elementary analysis, IR spectroscopy, and NMR spectroscopy. The elementary analyses corresponded exactly to the theoretical calculations. The spectroscopic data showed outstanding agreement with the structures of the compounds I-1, I-5, and I-7. The results obtained underlined the fact that the compounds I-1, I-5, and I-7 were present in a purity >99%. They were outstandingly suitable for preparing thermally curable and UV-curable (dual-cure) clearcoat materials.

### Examples 4 to 11

The Preparation of Compounds I-1 to I-8

The compounds I-1 (example 4), I-2 (example 5), I-3 (example 6), I-4 (example 7), I-5 (example 8), I-6 (example 9), I-7 (example 10) and 1-8 (example 11) were prepared in accordance with the general instructions described below. Here,

The compound IV-1 was used to prepare the inventive compound I-1, compound IV-2 to prepare the inventive compound I-2, compound IV-3 to prepare the inventive compound I-3, compound IV-4 to prepare the inventive compound I-4, IV-5 to prepare the inventive compound I-5, compound IV-6 to prepare the inventive compound I-6, IV-7 to prepare the inventive compound I-7 and compound IV-8 to prepare the inventive compound I-8.

A compound IV in solution in dichloromethane was charged to a suitable reaction vessel under inert gas. The solution was cooled to 0° C. and trimethylamine was added in amine group: hydroxyl group equivalents ratio=1:1. Thereafter acryloyl chloride was added in a carbon chloride group: hydroxyl group equivalents ratio=1:1. After a reaction time of 30 minutes the precipitated ammonium chloride was filtered off. The filtrate was washed with dilute aqueous acid in order to remove any excess trimethylamine still present. Thereafter the filtrate was treated with calcium carbonate in order to remove traces of acid, and the dichloromethane was distilled off. Compounds I-1 to I-8 were obtained with the following yields:

I-1 N-(2-acryloyloxyethyl)-2′-acryloyloxyethyl carbamate (81%),

I-2 N-(2-acryloyloxyethyl)-3′-acryloyloxypropyl carbamate (89.9%),

I-3 N-(2-acryloyloxyethyl)-3′-acryloyloxybutyl carbamate (97.2%)

I-4 1,2-bis(N-2-acryloyloxyethyloxycarbonylamino) ethane (66.4%)

I-5 1,3-bis(N-2-acryloyloxyethyloxycarbonylamino) propane (71.4%)

I-6 1,6-bis(N-2-acryloyloxyethyloxycarbonylamino) hexane (95.1%)

I-7 1,3-bis(N-2-acryloyloxyethyloxycarbonylamino-methyl) cyclohexane (99.7%) and

I-8 1,2-bis(2-acryloyloxyethyl)-2′-acryloyloxyethyl carbamate (66.4%)

The compounds I-1 to I-8 were characterized by means of elementary analysis, IR spectroscopy, and NMR spectroscopy. The elementary analyses corresponded exactly to the theoretical calculations. The spectroscopic data showed outstanding agreement with the structures of the compounds I-1 to I-8. The results obtained underlined the fact that the compounds I-1 to I-8, were present in a purity >99%. They were outstandingly suitable for preparing thermally curable and UV-curable (dual-cure) clearcoat materials.

### Preparation Example 9

The Preparation of a Hydroxyl-Containing Polyacrylate Resin (Binder)

For the preparation of the hydroxyl-containing polyacrylate resin, a steel reactor suitable for polymerization and equipped with stirrer, reflux condenser, and oil heating was charged with 810 parts by weight of Solventnaphtha® and this initial charge was heated to the polymerization temperature of 140° C. Thereafter a mixture of 148.2 parts by weight of tert-butyl peroxy-2-ethylhexanoate and 111 parts by weight of Solventnaphtha® was metered in over 4.75 hours. 15 minutes after the beginning of the initiator mixture feed a mixture of 185 parts by weight of styrene, 862 parts by weight of ethylhexyl acrylate, 500 parts by weight of hydroxyethyl methacrylate, 278 parts by weight of hydroxybutyl acrylate and 28 parts by weight of acrylic acid was metered in over 4 hours. After the end of the polymerization the solution was adjusted with further Solventnaphtha® to a solids content of 65% by weight. The polyacrylate resin had a hydroxyl number of 175 mg KOH/g.

### Examples 12 to 14

The Preparation of Clearcoat Materials and their Use for Producing Multicoat Paint Systems

Three stock varnishes were prepared by mixing the constituents indicated in the table and homogenizing the resulting mixtures.

TABLE 1
The material composition of the clearcoat
materials of examples 12 to 14

| | Example: | | |
|---|---|---|---|
| Constituent | 12 | 13 | 14 |
| Polyacrylate resin from | 35 | 35 | 35 |
| preparation example 9 | | | |
| Compound I-1 from example 1 | 30 | — | — |
| Compound I-5 from example 2 | — | 30 | — |
| Compound I-7 from example 3 | — | — | 30 |
| Irgacure ® 184 (commercial | 1 | 1 | 1 |
| photoinitiator from Ciba | | | |
| Specialty Chemicals) | | | |
| Lucirin ® TPO (commercial | 0.5 | 0.5 | 0.5 |
| photoinitiator from BASF | | | |
| Aktiengesellschaft) | | | |
| Byk ® (commercial silicone | 0.8 | 0.8 | 0.8 |
| additive from Byk Chemie) | | | |
| Tinuvin ® 292 (commercial | 1 | 1 | 1 |
| free-radical scavenger from | | | |
| Ciba Specialty Chemicals) | | | |
| Tinuvin ® 400 (commercial | 1 | 1 | 1 |
| UV absorber from Ciba | | | |
| Specialty Chemicals) | | | |
| Butyl acetate | 22.8 | 22.8 | 22.8 |

Additionally a curing agent solution was prepared from 64 parts by weight of isocyanatoacrylate Roskydal® UA VPLS 2327 (basis: trimer of hexamethylene diisocyanate; isocyanate group content: 12% by weight), 16 parts by weight of isocyanatoacrylate Roskydal® UA VP FWO 303-77 (basis: trimer of isophorone diisocyanate, 70.5% strength in butyl acetate, viscosity: 1 500 mPas; isocyanate group content: 6.7% by weight) and 11.5 parts by weight of Desmodur® N 3300 (trimer of hexamethylene diisocyanate) (all three products from Bayer AG) and also 8 parts by weight of butyl acetate.

The stock varnishes and the curing agent were each mixed in a weight ratio of 95:36.5, giving the dual-cure clearcoat materials of examples 12 to 14.

Multicoat paint systems were produced by coating steel panels with a cathodically deposited electrocoat, baked at 170° C. for 20 minutes, with a dry film thickness of from 18 to 22 μm. The steel panels were subsequently coated with a commercial two-component aqueous surfacer from BASF Coatings AG, as is commonly used for plastics substrates. The resultant surfacer films were baked at 90° C. for 30 minutes to give a dry film thickness of 35 to 40 μm. Thereafter a commercial black aqueous basecoat material from BASF Coatings AG was applied with a film thickness of from 12 to 15 μm, after which the resultant aqueous basecoat films were flashed off at 80° C. for 10 minutes. Subsequently, the dual-cure clearcoat materials from examples 12 to 14 were applied pneumatically, using a gravity-feed cup-type gun in one cross pass, with a film thickness of from 40 to 45 μm. The aqueous basecoat films and the clearcoat films were cured at room temperature for 5 minutes and at 80° C. for 10 minutes, followed by irradiation with UV light in a dose of 1 500 mJ/cm², and finally at 140° C. for 20 minutes.

The multicoat paint systems were very bright and had a high gloss. In addition their clearcoats were free from surface defects, were very adherent to the basecoats, hard, flexibly scratch-resistant, stable to weathering, resistant to chemicals, resistant to yellowing, and resistant to bird droppings.

1. A compound which can be activated by actinic radiation, comprising at least one urethane group and having the formula I:
X[N(R)—C(O)—O—C(R¹R²)—C(R³R⁴)—Y-Z]ₙ (1),
in which the index and the variables have the following meanings:
n is an integer from 1 to 5;
X is an at least n-valent, substituted or unsubstituted organic radical;
R is a hydrogen atom or a monovalent substituted or unsubstituted organic radical;
R¹-R⁴ independently of one another are a hydrogen atom, halogen atom or monovalent, substituted or unsubstituted organic radical, it being possible for at least two radicals to be cyclically linked to one another;
Y is a divalent, linking functional group containing at least one oxygen atom; and
Z is an organic radical containing at least one group which can be activated by actinic radiation;
with the proviso that at least for n=1 the radical R and/or the radical X are/is substituted by at least one substituent of the general formula II:
Z-Y- (II),
in which the variables Z and Y are as defined above.

2. The compound of claim 1, wherein n=1 or 2.

3. The compound of claim 1, wherein the bond which can be activated by actinic radiation in the radicals Z is a carbon-carbon double bond.

4. The compound of claim 3, wherein the radicals Z have the general formula III: 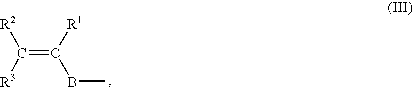
in which the variables R¹, R², and R³ are as defined above and the variable —B— is a single bond between the carbon atom of the carbon-carbon double bond and the divalent linking functional group Y or is a divalent substituted or unsubstituted linking organic radical X.

5. The compound of claim 4, wherein the radicals Z are vinyl radicals.

6. The compound of claim 1, wherein the divalent linking functional groups Y are selected from the group consisting of ether, carboxylate, carbonate, phosphorate, phosphonate, phosphite ester, and sulfonate groups.

7. The compound of claim 6, wherein the divalent linking functional groups Y are carboxylate groups.

8. A process for preparing compounds which can be activated by actinic radiation and have the general formula I, of claim 1, comprising reacting
(1) at least one compound which contains at least one urethane group and has the general formula IV:
X¹[N(R⁵)—C(O)—O—C(R¹R²)—C(R³R⁴)—OH]ₙ (IV),
wherein the index n and the variables R¹, R², R³ and R⁴ are as defined in claim 1 and the variable X¹ is an n-valent and the variable R⁵ a monovalent, hydroxyl-containing or hydroxyl-free substituted with substituents of the formula II being excluded or unsubstituted, organic radical; with the proviso that at least for n=1 the radical X¹ and/or radical R⁵ contain/contains one hydroxyl group; with
(2) at least one compound of the formula V:
Y¹-Z (V),
in which the variable Z is as defined in claim 1 and the variable Y¹ is a reactive functional group which forms at least one group Y with the hydroxyl group or groups of the compounds of the formula IV;
in a Y¹:OH equivalents ratio ≧1.0.

9. The process of claim 8, wherein the reactive functional group Y¹ is selected from the group consisting of halogen atoms, carboxylic acid, sulfonic acid, phosphoric acid, phosphonic acid, and phosphorous acid groups; carbonyl halide, sulfonic halide, phosphoric halide, phosphoryl halide groups; carboxylic anhydride, sulfonic anhydride, phosphoric anhydride, phosphonic anhydride, and phosphoryl anhydride groups; carboxylic, sulfonate, phosphate, phosphonate, and phosphite groups; and epoxide, N-methylol, and N-methylol ether groups.

10. The process of claim 8, wherein the compound of the formula VI is prepared by reacting
(1) at least one 1,3-dioxolan-2-one of the formula VI: 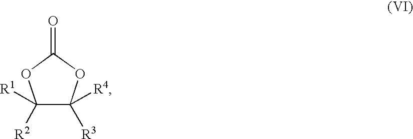
in which the variables R¹, R², R³, and R⁴ are as defined in claim 1; with
(2) at least one compound which contains at least one primary and/or secondary amino group and has the general formula VII:
X¹[N(R⁵)H]ₙ (VII),
in which the index and the variables X¹ and R⁵ are as defined above,
in an amino group: carbonate group equivalents ratio=0.8 to 1.2.

11. Compositions comprising compounds of the general formula I prepared by the process of claim 8 and curable by actinic radiation or by both thermal and actinic radiation or for preparing compositions curable by actinic radiation or by both thermally and by actinic radiation.

12. Curable compositions according to claim 11 selected from the group consisting of coating materials, adhesives or sealants for producing coatings, paint systems, adhesive films, seals and moldings and self-supporting films.
